(19) United States
(12) Patent Application Publication
(10) Pub. No.: US 2023/0126505 A1
(43) Pub. Date: Apr. 27, 2023

(54) ELECTRONIC DEVICE

(71) Applicant: InnoLux Corporation, Miao-Li County (TW)

(72) Inventors: Lien-Chen CHIEN, Miao-Li County (TW); Shih-Yuan FENG, Miao-Li County (TW); Yung-Kan CHEN, Miao-Li County (TW)

(21) Appl. No.: 17/949,722

(22) Filed: Sep. 21, 2022

(30) Foreign Application Priority Data
Oct. 21, 2021 (CN) 202111227826.8

(51) Int. Cl. F21V 29/67; F21V 29/74; F21V 29/56

(52) U.S. Cl. CPC F21V 29/677; F21V 29/74; F21V 29/56; F21V 3/00

(57) ABSTRACT

An electronic device includes a back frame, a first heat source, a second heat source, a guiding member and a fan. The first heat source is disposed on a first side of the back frame. The second heat source is disposed on a second side of the back frame. The guiding member is disposed on the second side of the back frame. The fan is disposed corresponding to the guiding member. At least part of an airflow path is formed between the first heat source and the second heat source.

### CROSS REFERENCE TO RELATED APPLICATION

This application claims the benefits of the Chinese Patent Application Serial Number 202111227826.8, filed on Oct. 21, 2021, the subject matter of which is incorporated herein by reference.

### BACKGROUND

### 1. Field of the Disclosure

The present disclosure relates to an electronic device and, more particularly, to an electronic device capable of improving heat dissipation effect.

### 2. Description of Related Art

In recent years, electronic devices, such as display devices, may need to increase the brightness of the backlight devices in order to achieve a high-contrast display effect, while this also causes the power consumption of the light source and/or circuit board of the backlight module to increase, resulting in temperature rise of the backlight device. However, the heat dissipation mechanism of the existing display device cannot effectively solve this problem.

Therefore, there is a need for an electronic device to alleviate and/or obviate the above problems.

### SUMMARY

The present disclosure provides an electronic device, which includes a back frame, a first heat source, a second heat source, a guide member, and a fan. The first heat source is disposed on a first side of the back frame. The second heat source includes a circuit board, wherein the circuit board is disposed on a second side of the back frame. The guide member is arranged on the second side of the back frame. The fan is disposed to correspond to the guide member, wherein at least a part of an airflow path is formed between the first heat source and the second heat source.

Other novel features of the present disclosure will become more apparent from the following detailed description when taken in conjunction with the accompanying drawings.

### BRIEF DESCRIPTION OF THE DRAWINGS

FIG. 1 is a schematic diagram of the electronic device according to an embodiment of the present disclosure;

FIG. 2 is a partial cross-sectional view of the electronic device in FIG. 1 taken along at the line A-A′ according to an embodiment of the present disclosure;

FIG. 3 is a partial cross-sectional view of the electronic device in FIG. 1 taken along t the line A-A′ according to another embodiment of the present disclosure;

FIG. 4 is a partial cross-sectional view of the electronic device in FIG. 1 taken along the line A-A′ according to another embodiment of the present disclosure;

FIG. 5A is a partial cross-sectional view of the electronic device in FIG. 1 taken along the line A-A′ according to another embodiment of the present disclosure;

FIG. 5B is a partial side view of the embodiment of FIG. 5A corresponding to the line B-B′ in FIG. 1;

FIG. 6 is a partial cross-sectional view of the electronic device in FIG. 1 taken along the line A-A′ according to another embodiment of the present disclosure;

FIG. 7 is a schematic diagram of the electronic device according to another embodiment of the present disclosure;

FIG. 8 is a schematic cross-sectional view of the electronic device in FIG. 7 taken along the line A-A′ according to an embodiment of the present disclosure;

FIG. 9 is a schematic cross-sectional view of the electronic device in FIG. 7 taken along the line A-A′ according to another embodiment of the present disclosure;

FIG. 10 is a schematic cross-sectional view of the electronic device in FIG. 7 taken along the line A-A′ according to another embodiment of the present disclosure;

FIG. 11 is a schematic cross-sectional view of the electronic device in FIG. 7 taken along the line A-A′ according to another embodiment of the present disclosure;

FIG. 12 is a schematic diagram of the electronic device according to another embodiment of the present disclosure;

FIG. 13 is a schematic cross-sectional view of the electronic device in FIG. 12 taken along the line C-C′ according to an embodiment of the present disclosure;

FIG. 14 is a schematic diagram of the electronic device according to another embodiment of the present disclosure; and

FIG. 15 is a schematic cross-sectional view of the electronic device in FIG. 14 taken along the line C-C′ according to another embodiment of the present disclosure.

### DETAILED DESCRIPTION OF EMBODIMENT

The implementation of the present disclosure is illustrated by specific embodiments to enable persons skilled in the art to easily understand the other advantages and effects of the present disclosure by referring to the disclosure contained therein. The present disclosure is implemented or applied by other different, specific embodiments. Various modifications and changes can be made in accordance with different viewpoints and applications to details disclosed herein without departing from the spirit of the present disclosure.

It should be noted that, in the specification and claims, unless otherwise specified, having “one” element is not limited to having a single said element, but one or more said elements may be provided.

In addition, in the specification and claims, unless otherwise specified, ordinal numbers, such as “first” and “second”, used herein are intended to distinguish components rather than disclose explicitly or implicitly that names of the components bear the wording of the ordinal numbers. The ordinal numbers do not imply what order a component and another component are in terms of space, time or steps of a manufacturing method. A “first” element and a “second” element may appear together in the same component, or separately in different components. The existence of an element with a larger ordinal number does not necessarily mean the existence of another element with a smaller ordinal number.

In addition, the term “adjacent” used herein may refer to describe mutual proximity and does not necessarily mean mutual contact.

In addition, the description of “when . . . ” or “while . . . ” in the present disclosure means “now, before, or after”, etc., and is not limited to occurrence at the same time. In the present disclosure, the similar description of “disposed on” or the like refers to the corresponding positional relationship between the two components, and does not limit whether there is contact between the two components, unless specifically limited. Furthermore, when the present disclosure recites multiple effects, if the word “or” is used between the effects, it means that the effects can exist independently, but it does not exclude that multiple effects can exist at the same time.

In addition, the terms “connect” or “couple” in the specification and claims not only refer to direct connection with another component, but also indirect connection with another component, or refer to electrical connection. Besides, the electrical connection may include a direct connection, an indirect connection, or a mode in which two components communicate through radio signals.

In addition, in the specification and claims, the term “almost”, “about”, “approximately” or “substantially” usually means within 20%, 10%, 5%, 3%, 2%, 1% or 0.5% of a given value or range. The quantity the given value is an approximate quantity, which means that the meaning of “almost”, “about”, “approximately” or “substantially” may still be implied in the absence of a specific description of “almost”, “about”, “approximately” or “substantially”. In addition, the terms “ranging from the first value to the second value” and “range between the first value and the second value” indicate that the range includes the first value, the second value, and other values between the first value and the second value.

In addition, the technical features of different embodiments disclosed in the present disclosure may be combined to form another embodiment.

In addition, the electronic device disclosed in the present disclosure may include a display device, an antenna device, a sensing device, a touch display device, a curved display device, or a free shape display device, but is not limited thereto. The electronic device may be a bendable or flexible electronic device. The electronic device may include, for example, liquid crystal, light emitting diode, fluorescence, phosphor, other suitable display media, or a combination thereof, but is not limited thereto. The light emitting diode may include, for example, an organic light emitting diode (OLED), a sub-millimeter light emitting diode (mini LED), a micro light emitting diode (micro LED) or a quantum dot (QD) light emitting diode (for example, QLED, QDLED) or other suitable materials or a combination thereof, but is not limited thereto. The display device may include, for example, a tiled display device, but is not limited thereto. The antenna device may be, for example, a liquid crystal antenna, but is not limited thereto. The antenna device may include, for example, a tiled antenna device, but is not limited thereto. It should be noted that the electronic device may be a combination of the foregoing, but is not limited thereto. In addition, the appearance of the electronic device may be rectangular, circular, polygonal, a shape with curved edges, or other suitable shapes. The electronic device may have peripheral systems such as a driving system, a control system, a light source system, a shelf system, etc., to support a display device, an antenna device, or a tiled device. Hereinafter, the display device will be used as an electronic device for illustrative purpose only, but the disclosure is not limited thereto.

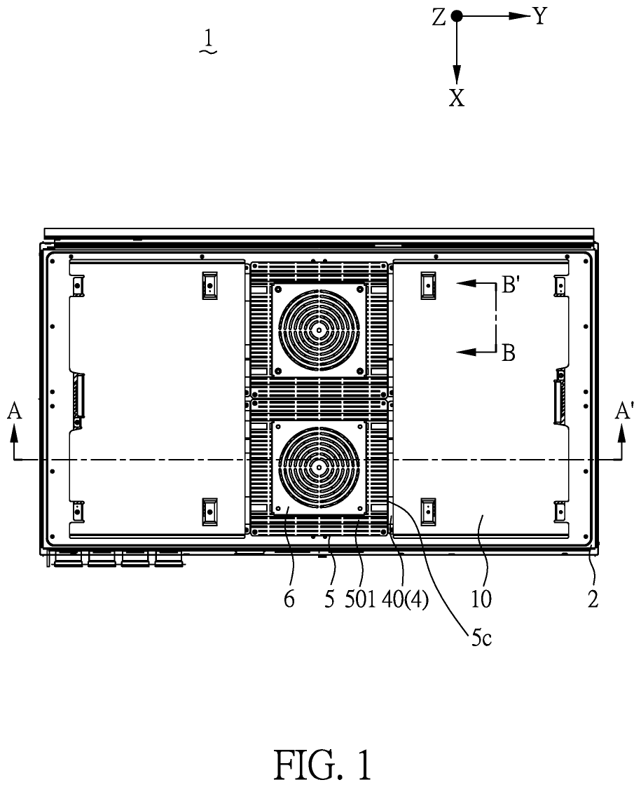

Please refer to FIG. 1 and FIG. 2 at the same time. FIG. 1 is a schematic diagram (a top view) of the electronic device 1 according to an embodiment of the present disclosure, and FIG. 2 is a partial cross-sectional view of the electronic device 1 in FIG. 1 taken along the line A-A′ according to an embodiment of the present disclosure. In addition, for the convenience of description, the cross-sectional view is presented with the light-emitting surface of the electronic device 1 facing downward (for example, toward the direction opposite to the Z direction in FIG. 2).

As shown in FIG. 1 and FIG. 2, the electronic device 1 includes a back frame 2, at least one first heat source 3, at least one second heat source 4, at least one guide member 5 and at least one fan 6. The back frame 2 has a first side 2a and a second side 2b. The first heat source 3 is disposed on the first side 2a of the back frame 2. The second heat source 4 may include a circuit board 40 and electronic components (not shown) disposed on the circuit board 40. The circuit board 40, the guide member 5 and the fan 6 are disposed on the second side 2 b of the back frame 2. The guide member 5 may have a first side 5a and a second side 5b opposite to each other. The first side 5a of the guide member 5 may be disposed adjacent to the second side 2b of the back frame 2, and the fan 6 may be disposed adjacent to the second side 5b of the guide member 5, but it is not limited thereto. In one embodiment, the fan 6 may be directly abutted against the second side 5b of the guide member 5. In one embodiment, the first side 5a of the guide member 5 may be directly abutted against the second side 2b of the back frame 2. In addition, the fan 6 may be disposed corresponding to the guide member 5, for example, in a normal direction (e.g., the Z direction) of the second side 5b of the guide member 5, and the fan 6 and the guide member 5 at least partially overlap, or may be regarded as stacked.

When the fan 6 operates (e.g., rotates), at least part of an airflow path (as denoted by R in FIG. 2) may be formed between the first heat source 3 and the second heat source 4. For example, when the fan 6 operates, an air flow may be generated, and part of the air may flow to the second heat source 4 (such as the circuit board 40) through the fan 6 and the guide member 5, so that air flows around the second heat source 4, and thus part of the airflow path (e.g., R) may be formed between the second heat source 4 and the first heat source 3, but it is not limited thereto. With the flow of air, the heat dissipation of the first heat source 3 or the second heat source 4 can be accelerated. It is noted that, when the fan 6 operates, other airflow paths may also be generated in addition to the aforementioned airflow path. Therefore, the present disclosure neither limits to have only a single airflow path, nor limits all air to flow along the aforementioned airflow path. In addition, the airflow paths (e.g., R) and directions (e.g., arrow directions) indicated in the drawings are for illustrative purpose only, but are not intended to limit the present disclosure.

Next, the details of the components will be described.

In one embodiment, the material of the back frame 2 may include a material with a high heat transfer coefficient, for example metals or alloys such as copper, aluminum, aluminum alloy, sheet metal or other suitable materials, or a combination thereof, but it not limited thereto. In another embodiment, the material of the back frame 2 may include plastic, wood, ceramics, glass, other suitable materials or a combination thereof, but it is not limited thereto. In one embodiment, heat conduction may be performed among the first heat source 3, the back frame 2 and the guide member 5, but it is not limited thereto.

In one embodiment, the first heat source 3 may be various objects that can generate thermal energy. In one embodiment, the first heat source 3 may include at least one light-emitting source 31 and a circuit carrier board 32, wherein the light-emitting source 31 may be disposed on the circuit carrier board 32. In this case, the first heat source 3 may be, for example, one or multiple light bars, and the light-emitting source 31 may be a light emitting diode or a cold cathode fluorescent lamp (CCFL), but it is not limited thereto. In another embodiment, the first heat source 3 may also be other devices that generate heat energy during operation, such as a display panel, a memory, a processor, a motherboard, a chip, a circuit, an antenna or a motor, but it is not limited thereto. For the convenience of description, the first heat source 3 being a light bar is taken as an example for illustration. In addition, in one embodiment, the first heat source 3 may be fixed on the first side 2a of the back frame 2, but it is not limited thereto. In one embodiment, the first heat source 3 may be directly attached to the first side 2a of the back frame 2 but, in another embodiment, there may also be a space between the first heat source 3 and the back frame 2 (for example, referring to FIG. 9), while it is not limited thereto. In addition, in one embodiment, the electronic device 1 further includes a diffuser plate 11 disposed adjacent to the first side 2a of the back frame 2, wherein there may be an interval between the first heat source 3 and the diffuser plate 11. In one embodiment, the diffuser plate 11 may be disposed between the back frame 2 and the plastic frame 12, but it is not limited thereto. In addition, a dimming device 13 may be disposed on the diffuser plate 11; for example, the dimming device 13 may be disposed on the external side of the diffuser plate 11 (for example, the side away from the first heat source 3). In one embodiment, the dimming device 13 may be, for example, a display panel, but it is not limited thereto. In one embodiment, the back frame 2, the first heat source 3 and the diffuser plate 11 may be, for example, part of a backlight device of a display device, wherein the backlight device may be a direct type backlight device, but it not limited thereto.

In one embodiment, the circuit board 40 may be electrically connected to the circuit carrier board 32 of the first heat source 3, and a controller (not shown) may be disposed on the circuit board 40 for controlling the brightness of the light-emitting source 31, but it is not limited thereto. In addition, in one embodiment, a plurality of support members 7 may be disposed between the circuit board 40 and the back frame 2. The support member 7 may be used to support the circuit board 40 to form a space between the circuit board 40 and the back frame 2. In another embodiment, there may be no support member 7 disposed between the circuit board 40 and the back frame 2, and the circuit board 40 may be directly abutted against the second side 2b of the back frame 2 (not shown). In one embodiment, when the circuit board 40 is abutted against the back frame 2, the second heat source 4 may include at least part of the circuit board 40 and the back frame 2 (for example, the portion in contact with the circuit board 40), but it is not limited thereto.

In one embodiment, the guide member 5 may be a heat sink, but it is not limited thereto. When the guide member 5 is a heat sink, it can assist the first heat source 3 and the back frame 2 to dissipate heat, for example, in a heat conduction manner, but it is not limited thereto. In one embodiment, the guide member 5 may be a fin type heat sink, and may include at least a flow channel 501 (as shown in FIG. 1). In one embodiment, the flow channel 501 may extend to at least one edge 5c of the guide member 5, and the edge 5c of the guide member 5 has at least one air outlet. Therefore, when the fan 6 operates to generate airflow, at least part of the air in the guide member 5 may flow out from the air outlet of the edge 5c through the flow channel 501. In addition, in one embodiment, when the guide member 5 includes a plurality of flow channels 501, the flow channels 501 may be in a horizontal arrangement, a radial arrangement or an arrangement in any shape, but it is not limited thereto. In addition, the shape of the flow channel 501 is not limited, and the shape of each flow channel 501 may also be different. In one embodiment, the guide member 5 may be obtained from various products on the market, but it is not limited thereto. In addition, in one embodiment, the material of the guide member 5 may include a material with high thermal conductivity, such as copper, aluminum, aluminum alloy and other metals or alloys, but it is not limited thereto.

The fan 6 may be used for air intake; for example, it may be used to draw external air into the guide member 5. In other embodiments, the present disclosure may also provide other fans for air extraction (please refer to the embodiments in FIGS. 12 to 16B).

In addition, in one embodiment, the circuit board 40 may be disposed adjacent to the edge 5c of the guide member 5, and the air outlet of the edge 5c may face the circuit board 40. Therefore, when the fan 6 operates, at least part of the air in the guide member 5 may flow out from the air outlet of the edge 5c, and flow to the circuit board 40. At this moment, air flows around the circuit board 40 so that the heat dissipation effect can be improved. In addition, when the support member 7 is arranged between the circuit board 40 and the back frame 2, part of the air may also flow into the space between the circuit board 40 and the back frame 2, so that the heat dissipation effect of the circuit board 40 and the back frame 2 can be improved, while the present disclosure is not limited thereto.

In addition, a board cover 10 may be provided above the circuit board 40. The board cover 10 may shield at least part of the circuit board 40 to protect the circuit board 40. In one embodiment, there may be a space between the circuit board 40 and the board cover 10; that is, the board cover 10 may not be in contact with the circuit board 40. In one embodiment, the board cover 10 may be disposed above the circuit board 40 in various practicable manners; for example, the board cover 10 may be locked on the back frame 2 or other mechanisms, but it is not limited thereto. In one embodiment, the board cover 10 may overlap the back frame 2 and a space may be defined in the overlap portion between the board cover 10 and the back frame 2, and the space may have at least one first opening 101, so that part of the air may pass through the first opening 101, but it is not limited thereto. In other embodiments, there may be no board cover 10 provided in the present disclosure.

As a result, when the fan 6 operates, the flow of air may accelerate the heat dissipation of the electronic device 1, while the present disclosure is not limited thereto.

The present disclosure may also have different implementation aspects.

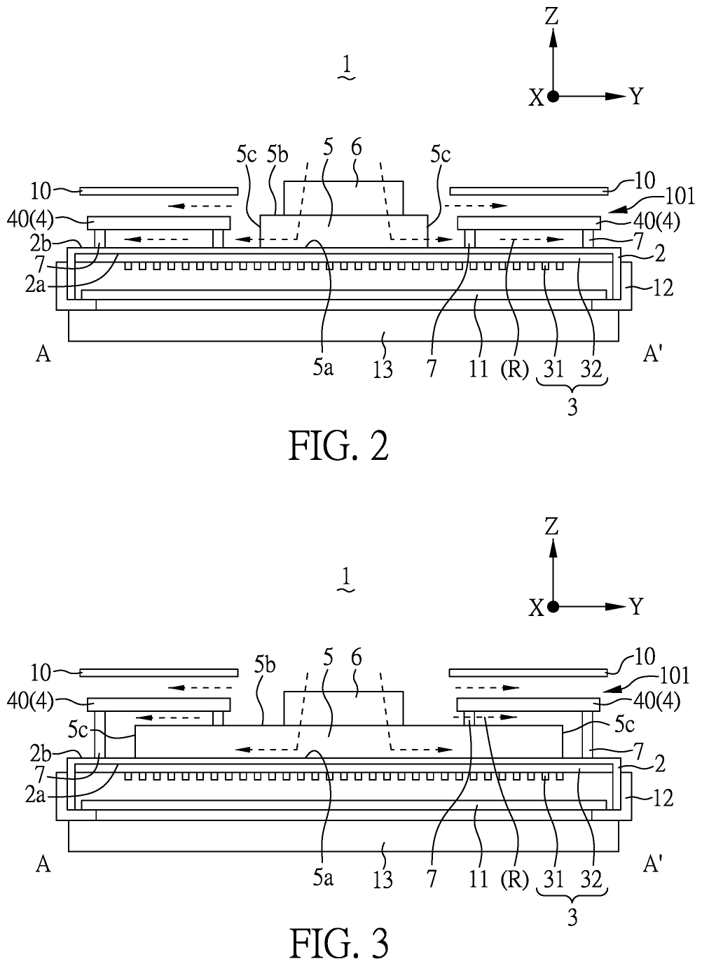

FIG. 3 is a partial cross-sectional view of the electronic device in FIG. 1 taken along t the line A-A′ according to another embodiment of the present disclosure, and please refer to FIG. 3 and FIGS. 1 and 2 at the same time. Since some features of the embodiment of FIG. 3 are similar to those described in the description of the embodiment of FIG. 2, a detailed description for these features is deemed unnecessary, and the following description mainly focuses on the differences.

Compared with the embodiment of FIG. 2, the guide member 5 of the embodiment of FIG. 3 has a longer extension length in the tangential direction (e.g., the Y direction) of the second side 2b of the back frame 2, and at least part of the circuit board 40 may be disposed on the guide member 5, and the two may be disposed correspondingly; for example, the two may at least partially overlap in a normal direction (e.g., the Z direction) of the circuit board 40. In other words, at least part of the circuit board 40 and the fan 6 may be disposed on the second end 5b of the guide member 5 at the same time.

As shown in FIG. 3, in one embodiment, a support member 7 may be provided between the circuit board 40 and the back frame 2, so that an interval may be formed between at least part of the circuit board 40 and at least part of the back frame 2, but it is not limited thereto. In one embodiment, a support member 7 may also be disposed between the circuit board 40 and the guide member 5, so that an interval may also be formed between at least part of the circuit board 40 and at least part of the guide member 5, but it is not limited thereto. In one embodiment, the interval between the circuit board 40 and the back frame 2 may be in connection with the interval between the circuit board 40 and the guide member 5, but it is not limited thereto. With the air flowing in the interval, the heat dissipation effect of the electronic device 1 can be improved.

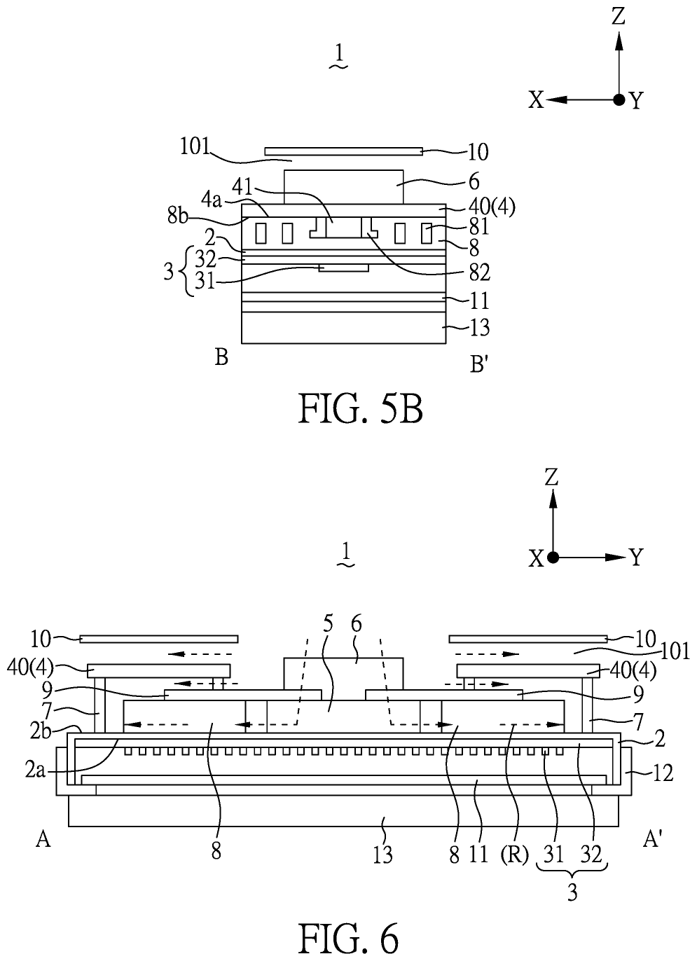

In addition, in another embodiment, there may be no support member 7 provided between the circuit board 40 and the guide member 5. At this moment, the circuit board 40 may be directly abutted against the second side 5b of the guide member 5, so that the guide member 5 may perform heat conduction on the circuit board 40. As a result, the guide member 5 may assist the first heat source 3 and the circuit board 40 to dissipate heat, so as to achieve the effect of double-sided heat dissipation. In addition, in one embodiment, the second side 5b of the guide member 5 may be provided with grooves for accommodating components on the circuit board 40 (referring to and modifying the embodiments in FIGS. 5A and 5B), but it is not limited thereto.

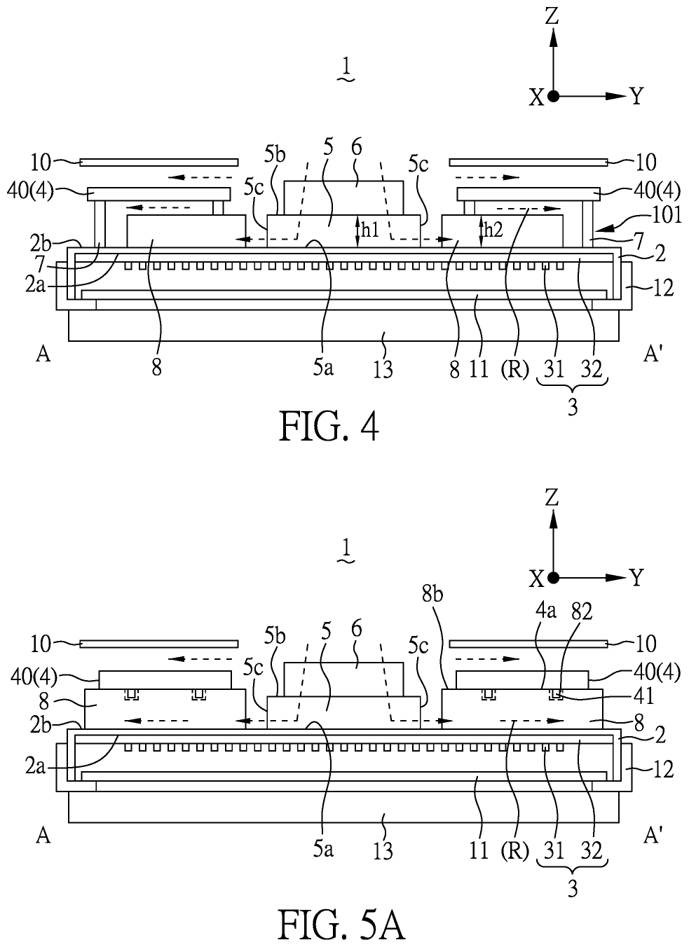

FIG. 4 is a partial cross-sectional view of the electronic device in FIG. 1 taken along the line A-A′ according to another embodiment of the present disclosure, and please refer to FIG. 4 and FIGS. 1 to 3 at the same time. Since some features of the embodiment of FIG. 4 are similar to those described in the embodiment of FIG. 2, a detailed description for these features is deemed unnecessary, and the following description mainly focuses on the differences.

Compared with the embodiment of FIG. 2, the electronic device 1 of the embodiment of FIG. 4 further includes a second guide member 8 disposed on the second side 2b of the back frame 2. In one embodiment, the second guide member 8 may be disposed adjacent to the guide member 5, for example, adjacent to the edge 5c of the guide member 5, but it is not limited thereto. In addition, the circuit board 40 may be correspondingly disposed on the second guide member 8. For example, in the normal direction (e.g., the Z direction), the circuit board 40 and the second guide member 8 may at least partially overlap, but it not limited thereto. In one embodiment, a support member 7 may be disposed between the circuit board 40 and the second guide member 8 or between the circuit board 40 and the back frame 2, so that an interval space may be formed between at least part of the circuit board 40 and at least part of the second guide member 8, and an interval space may be formed between at least part of the circuit board 40 and at least part of the back frame 2. In one embodiment, the interval space between the circuit board 40 and the second guide member 8 may be in connection with the interval space between the circuit board 40 and the back frame 2, but it is not limited thereto. In addition, in another embodiment, there may be no support member 7 disposed between the circuit board 40 and the second guide member 8. In this case, the circuit board 40 may be directly abutted against the second side 8b of the second guide member 8, while the present disclosure is not limited thereto.

In one embodiment, the second guide member 8 may be a heat sink, but it is not limited thereto. In one embodiment, the second guide member 8 may be a fin type heat sink, which may also include one or more flow channels (not shown). In addition, similar to the guide member 5, when the second guide member 8 includes a plurality of flow channels, the flow channels may be in horizontal arrangement, a radial arrangement or an arrangement in any shape, but it is not limited thereto, and the shape of each flow channel is not limited. In addition, the arrangement of the flow channels 501 of the guide member 5 and the arrangement of the flow channels of the second guide member 8 may be the same or different, which is not limited in the present disclosure. In one embodiment, the material of the second guide member 8 may include a material with high thermal conductivity, such as aluminum alloy, sheet metal, copper, aluminum, etc., while it is not limited thereto.

In addition, in one embodiment, the thickness h1 of the guide member 5 in the normal direction (e.g., the Z direction) and the thickness h2 of the second guide member 8 in the normal direction (e.g., the Z direction) may be the same or different. For example, the thickness h1 of the guide member 5 may be greater than, equal to or smaller than the thickness h2 of the second guide member 8.

As a result, the fan 6, the guide member 5 and the second guide member 8 can assist the first heat source 3 to dissipate heat by means of, such as but not limited to, heat conduction. In addition, when the fan 6 rotates, part of the air may flow in the channels of the guide member 5 and the second guide member 8, which can accelerate the heat dissipation of the electronic device 1. In addition, with the guide member 5 and the second guide member 8, it is able to achieve the effect of heat dissipation at the surrounding of the guide member 5 and the second guide member 8.

FIG. 5A is a partial cross-sectional view of the electronic device in FIG. 1 taken along the line A-A′ according to another embodiment of the present disclosure and FIG. 5B is a partial side view of the embodiment of FIG. 5A corresponding to the line B-B′ in FIG. 1, and please refer to FIGS. 5A and 5B and FIGS. 1 to 4 at the same time. Since some features of the embodiment of FIGS. 5A and 5B are similar to those described in the embodiment of FIG. 4, a detailed description for these features is deemed unnecessary, and the following description mainly focuses on the differences.

Compared with the embodiment of FIG. 4, the second guide member 8 and the guide member 5 of the embodiment of FIGS. 5A and 5B may be disposed adjacent to each other, and the second guide member 8 may have at least one groove 82, while at least one electronic component 41 may be disposed on the first side 4a of the circuit board 41, and there may be no support member 7 disposed between the circuit board 40 and the second guide member 8, so that the circuit board 40 may be directly abutted against the second guide member 8. The grooves 82 may be disposed corresponding to the electronic components 41, so that, when the first side 4a of the circuit board 40 is abutted against the second side 8b of the second guide member 8, the grooves 82 may accommodate the electronic components 41. In one embodiment, the electronic component 41 may be abutted against the groove 82, so that the second guide member 8 may assist the electronic component 41 to dissipate heat by, such as but not limited to, heat conduction. In one embodiment, the electronic component 41 may be, for example, a control chip of the light-emitting source 31, but it is not limited thereto.

As shown in FIG. 5B, the grooves 82 may be arranged between the plurality of flow channels 81 of the second guide member 8, so that, when the electronic components 41 are accommodated in the grooves 82, the air circulating in the flow channels 81 may also increase the heat dissipation efficiency of the electronic components 41. In addition, the electronic components 41 may be accommodated in the grooves 82, and the thickness of the electronic device 1 in the normal direction (e.g., the Z direction) can be reduced.

As a result, the heat dissipation effect of the electronic device 1 can be improved, or the thickness of the electronic device 1 in the normal direction (e.g., the Z direction) can be reduced.

FIG. 6 is a partial cross-sectional view of the electronic device in FIG. 1 taken along the line A-A′ according to another embodiment of the present disclosure, and please refer to FIG. 6 and FIGS. 1 to 5B at the same time. Since some features of the embodiment of FIG. 6 are similar to those described in the embodiment of FIG. 4, a detailed description for these features is deemed unnecessary, and the following description mainly focuses on the differences.

Compared with the embodiment of FIG. 4, the electronic device 1 of the embodiment of FIG. 6 further includes at least one heat pipe 9 disposed on the second side 2b of the back frame 2. In one embodiment, the heat pipe 9 may be disposed on the guide member 5 or in the flow channel 501 of the guide member 5, or may also be disposed at other parts of the guide member 5, while it is not limited thereto. In one embodiment, the second guide member 8 and the guide member 5 may be disposed adjacent to each other, and the heat pipe 9 may also be disposed on the second guide member 8 or in the flow channel of the second guide member 8, or may also be disposed at other parts of the second guide member 8, while it is not limited thereto. For example, in one embodiment, the heat pipe 9 may be disposed on the guide member 5 and the second guide member 8 at the same time. In another embodiment, the heat pipe 9 may be disposed between the guide member 5 and the second guide member 8 (not shown in the figure); for example, one end of the heat pipe 9 may be connected to the edge 5c of the guide member 5, and the other end of the heat pipe 9 may be connected to an edge of the second guide member 8. In another embodiment, the guide member 5 and the second guide member 8 may each be provided with a heat pipe 9, but the present disclosure is not limited thereto. In one embodiment, the inside of the heat pipe 9 may be filled with condensed liquid, such as but not limited to pure water, which can be used to assist the heat dissipation of the guide member 5 or the second guide member 8, but it not limited thereto.

With the arrangement of the heat pipe 9, the heat dissipation effect of the electronic device 1 can be further improved.

In addition, the guide member 5 of the present disclosure may also have other implementation aspects.

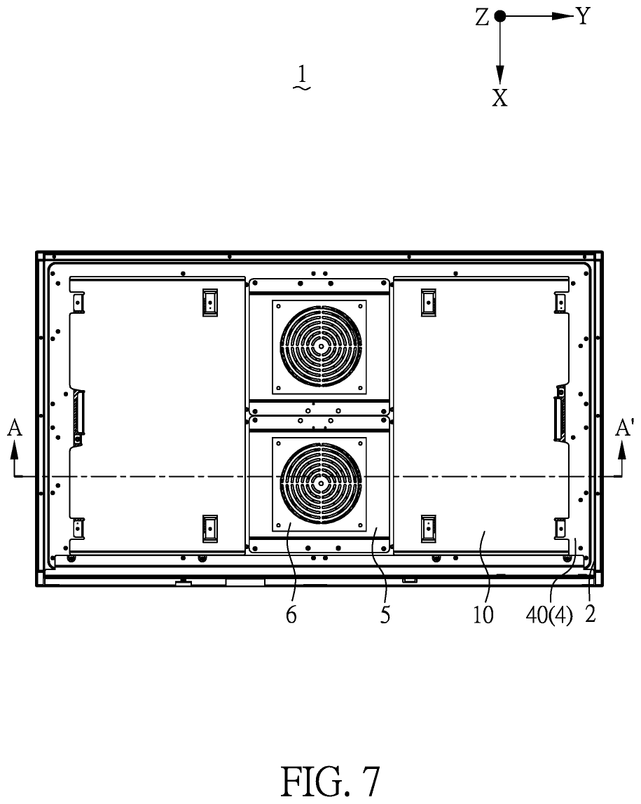

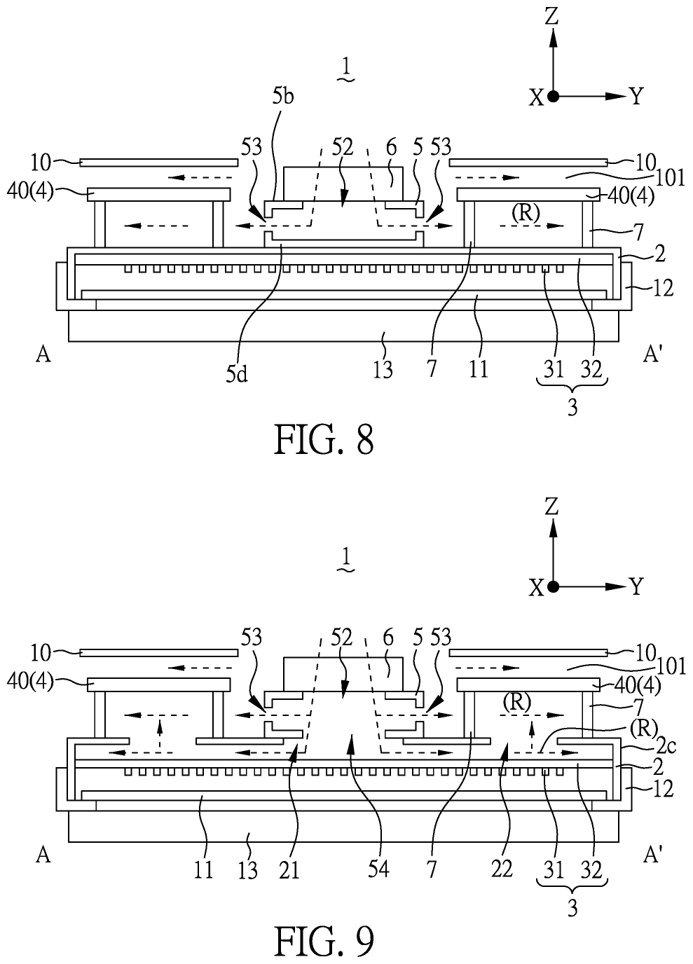

FIG. 7 is a schematic diagram of the electronic device 1 according to another embodiment of the present disclosure, and FIG. 8 is a schematic cross-sectional view of the electronic device in FIG. 7 taken along the line A-A′ according to an embodiment of the present disclosure. Since some details and configurations of the embodiments in FIGS. 7 and 8 are similar to those described in the embodiment of FIGS. 1 and 2, only the differences are described in the following.

As shown in FIG. 7 and FIG. 8, the guide member 5 of this embodiment may be a fan support frame and, in the normal direction (e.g., the Z direction), the guide member 5 may be arranged between the back frame 2 and the fan 6. In one embodiment, the guide member 5 may be a hollow structure, but it is not limited thereto. In one embodiment, the second side 5b of the guide member 5 may have an opening (hereinafter referred to as the second opening 52), and the fan 6 may be disposed corresponding to the second opening 52; for example, in the normal direction (e.g., the Z direction), the second opening 52 at least partially overlaps the fan 6. In addition, at least one edge of the guide member 5 may be provided with another opening (hereinafter referred to as the third opening 53), wherein the third opening 53 may be configured to face the circuit board 40. As a result, the third opening 53 may be provided with an air outlet. In one embodiment, the material of the fan support frame may be applied to the material of the heat sink in the embodiment of FIG. 2, and thus it will not be described in detail. In addition, as shown in FIG. 8, the guide member 5 may have a bottom cover 5d disposed between the back frame 2 and the second side 5b, and the bottom cover 5d may be in direct contact with the back frame 2. However, in some embodiments, the guide member 5 may not need the bottom cover 5d and, in other embodiments, other medium layers may be included between the bottom cover 5d and the back frame 2.

In this embodiment, when the fan 6 rotates, the guide member 5 may be part of the airflow path, wherein at least part of the air may flow into the guide member 5 from the second opening 52, and at least part of the air may flow into the circuit board 40 from the third opening 53, so that air may flow around the circuit board 40 and flow out from the first opening 101. As a result, the heat dissipation effect of the electronic device 1 can be improved.

FIG. 9 is a schematic cross-sectional view of the electronic device in FIG. 7 taken along the line A-A′ according to another embodiment of the present disclosure, and please refer to FIG. 9 and FIGS. 1 to 8 at the same time. Since some details and configurations of the embodiment of FIG. 9 are similar to those described in the embodiment of FIG. 8, only the differences will be described in the following.

In the embodiment of FIG. 9, the back frame 2 may be provided with a first through hole 21, and the fan 6 may be disposed adjacent to the first through hole 21. In one embodiment, the fan 6 may be disposed corresponding to the first through hole 21; for example, in the normal direction (e.g., the Z direction), the first through hole 21 and the fan 6 at least partially overlap. In addition, the guide member 5 may be provided with an opening corresponding to the first through hole 21 (hereinafter referred to as the fourth opening 54). In addition, an interval space may be provided between the back frame 2 and the first heat source 3. In one embodiment, in order to form the interval space, the first heat source 3 may be fixed on the end 2c of the back frame 2 or on other components, or a support member may be provided between the first heat source 3 and the back frame 2, while it is not limited thereto. Therefore, when the fan 6 operates, at least part of the air may flow in between the back frame 2 and the first heat source 3 through the fourth opening 54 and the first through hole 21, and flow in the interval space between the back frame 2 and the first heat source 3.

In addition, in one embodiment, the back frame 2 may be further provided with at least one second through hole 22. The position of the second through hole 22 of the back frame 2 may be adjacent to the end portion 2c of the back frame 2, for example, near the circuit board 40, but it is not limited thereto. In this case, at least part of the air between the back frame 2 and the first heat source 3 may flow out through the second through holes 22, but it is not limited thereto. In addition, air may also flow between the circuit board 40 and the first heat source 3 in this embodiment, so that part of an airflow path (denoted as R) may also be formed between the second heat source 4 and the first heat source 3. In addition, in another embodiment, the end portion 2c of the back frame 2 may also be provided with through holes, but it is not limited thereto.

As a result, air may flow between the back frame 2 and the first heat source 3, which may further enhance the heat dissipation effect of the electronic device 1.

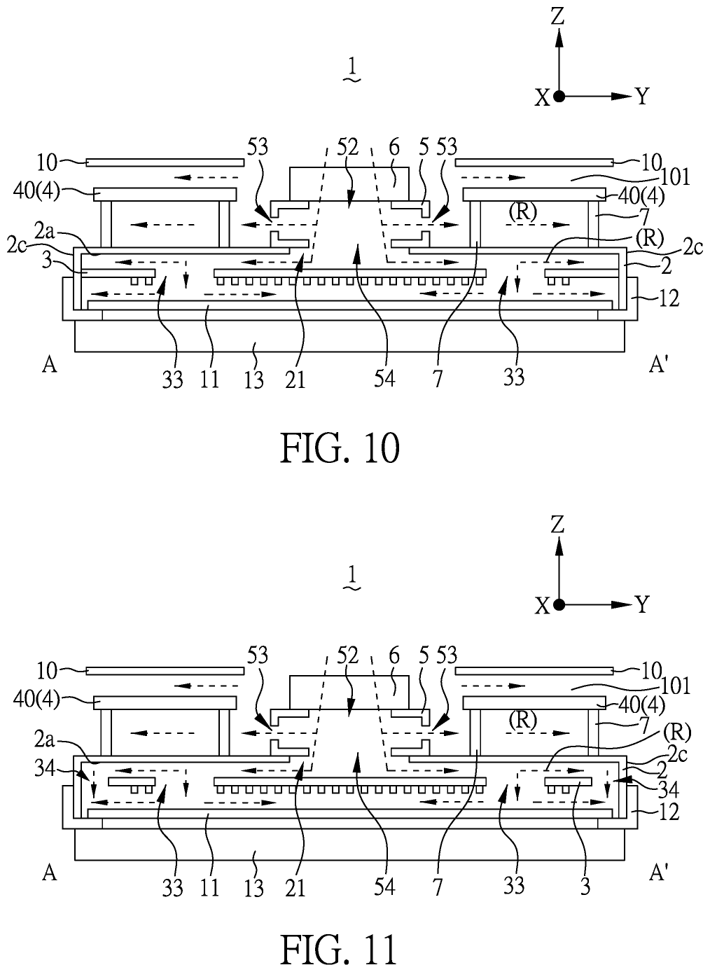

FIG. 10 is a schematic cross-sectional view of the electronic device in FIG. 7 taken along the line A-A′ according to another embodiment of the present disclosure, and please refer to FIG. 10 and FIGS. 1 to 9 at the same time. Since some details and configurations of the embodiment of FIG. 10 are similar to those described in the embodiment of FIG. 9, only the differences will be described in the following.

In the embodiment of FIG. 10, not only the back frame 2 is provided with the first through hole 21, but also the first heat source 3 may also be provided with at least one through hole (hereinafter referred to as the third through hole 33). Therefore, when the fan 6 operates, at least part of the air may flow into the interval space between the back frame 2 and the first heat source 3 through the fourth opening 54 and the first through hole 21 of the back frame 2, and flow in the interval space, In addition, at least part of the air in the interval space may flow into an interval space between the first heat source 3 and the diffuser plate 11 through the third through hole 33 of the first heat source 3, so that air may flow between the diffuser plate 11 and the first heat source 3. Therefore, air may flow on both sides of the first heat source 3 in the normal direction (e.g., the Z direction). In addition, air may also flow between the circuit board 40 and the back frame 2 or between the back frame 2 and the first heat source 3 in this embodiment, so that part of an airflow path may be formed between the second heat source 4 and the first heat source 3 part (denoted as R).

In one embodiment, the end 2c of the back frame 2 may also be provided with a through hole (not shown), so that the air in the interval space between the first heat source 3 and the diffuser plate 11 may also flow out through the through hole, but it is not limited thereto.

As a result, air may flow around the first heat source 3, so that the heat dissipation effect of the electronic device 1 can be improved.

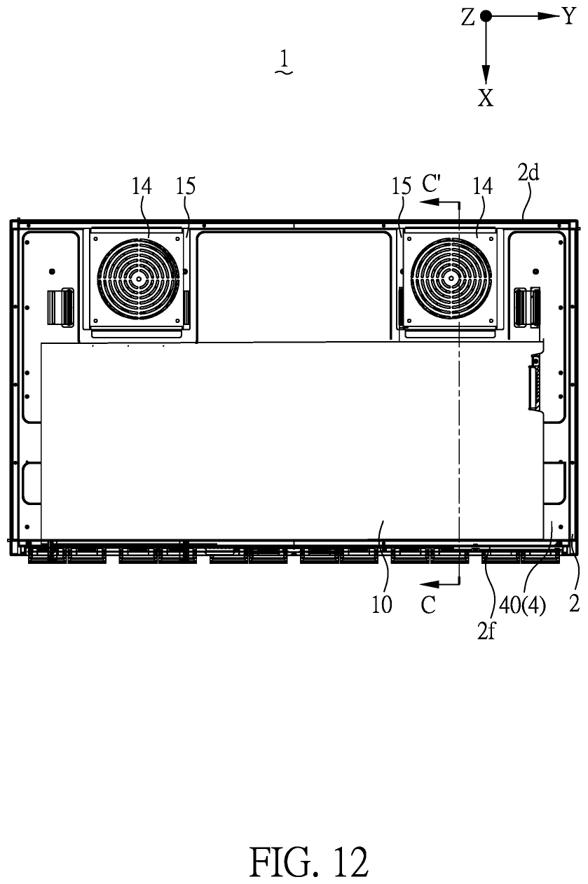

FIG. 11 is a schematic cross-sectional view of the electronic device in FIG. 7 taken along the line A-A′ according to another embodiment of the present disclosure, and please refer to FIG. 11 and FIGS. 1 to 10 at the same time. Since some details and configurations of the embodiment of FIG. 11 are similar to those described in the embodiment of FIG. 10, only the differences will be described in the following.

In the embodiment of FIG. 11, the first heat source 3 and the end portion 2c of the back frame 2 may be at least partially not in contact; that is, in the tangential direction (e.g., the Y direction), there may be at least one interval 34 between the first heat source 3 and the ends 2c of the back frame 2.

Therefore, when the fan 6 operates, at least part of the air may also pass through the interval 34 and flow in the interval between the first heat source 3 and the diffuser plate 11. As a result, air may flow around the first heat source 3, which can improve the heat dissipation effect of the electronic device 1.

In addition, the electronic device 1 of the present disclosure may also have different heat dissipation mechanisms.)

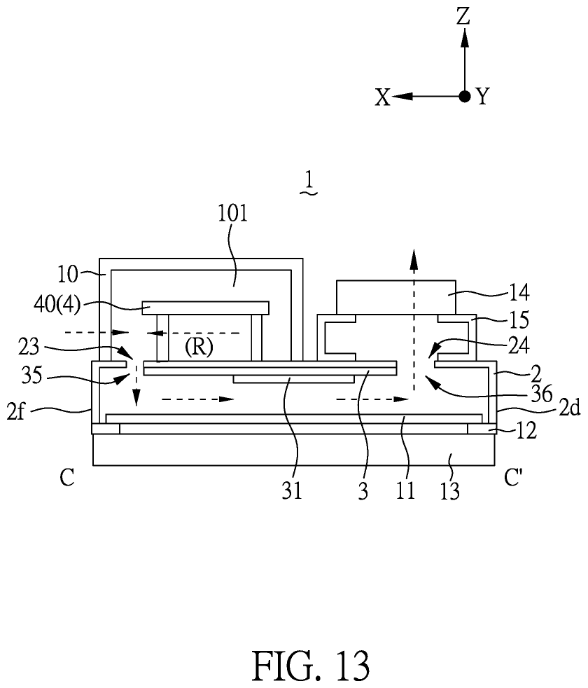

FIG. 12 is a schematic diagram of the electronic device according to another embodiment of the present disclosure, and FIG. 13 is a schematic cross-sectional view of the electronic device in FIG. 12 taken along the line C-C′ according to an embodiment of the present disclosure. Since some details and configurations of the embodiment of FIGS. 12 and 13 are similar to those described in the embodiment of FIGS. 1 and 2, only the differences will be described in the following.

In the embodiment of FIGS. 12 and 13, there may be at least one through hole (hereinafter referred to as the fourth through hole 23) near a first end 2f on the back frame 2, and there may be at least one through hole (hereinafter referred to as the fifth through hole 24) near a second end 2d on the back frame 2, wherein the first end 2f is opposite to the second end 2d. In addition, a fan 14 may be disposed adjacent to the fifth through hole 24, or the fan 14 may be disposed above the fifth through hole 24 correspondingly. For example, in the normal direction (e.g., the Z direction), the fan 14 and the fifth through hole 24 may at least partially overlap with each other. In this embodiment, the fan 14 may be configured to draw air at the fifth through hole 24, but it is not limited thereto. In addition, another fan support frame 15 may be disposed between the fan 14 and the back frame 2, but it is not limited thereto. It is noted that the positions of the fan 14 and the through holes in FIG. 13 are for illustrative purpose only and not intended to be limiting of the present disclosure.

In addition, in one embodiment, the first heat source 3 may be provided with two opposite intervals (hereinafter referred to as the second interval 35 and the third interval 36), wherein the second interval 35 may be disposed adjacent to the fourth through hole 23, and the third interval 36 may be disposed adjacent to the fifth through hole 24, but it is not limited thereto.

In one embodiment, when the fan 14 operates, at least part of the air between the circuit board 40 and the back frame 2 or other places may flow in between the first heat source 3 and diffuser plate 11 through the fourth through holes 23 and the second interval 35, but it is not limited thereto. In addition, at least part of the air between the first heat source 3 and the diffuser plate 11 may also flow to the fan 14 through the third interval 36 and the fifth through hole 24 for being discharged out of the electronic device 1 through the fan 14.

As a result, the heat dissipation effect of the electronic device 1 can be improved.

In addition, the embodiment of FIG. 12 and FIG. 13 may also be combined with the aforementioned embodiments.

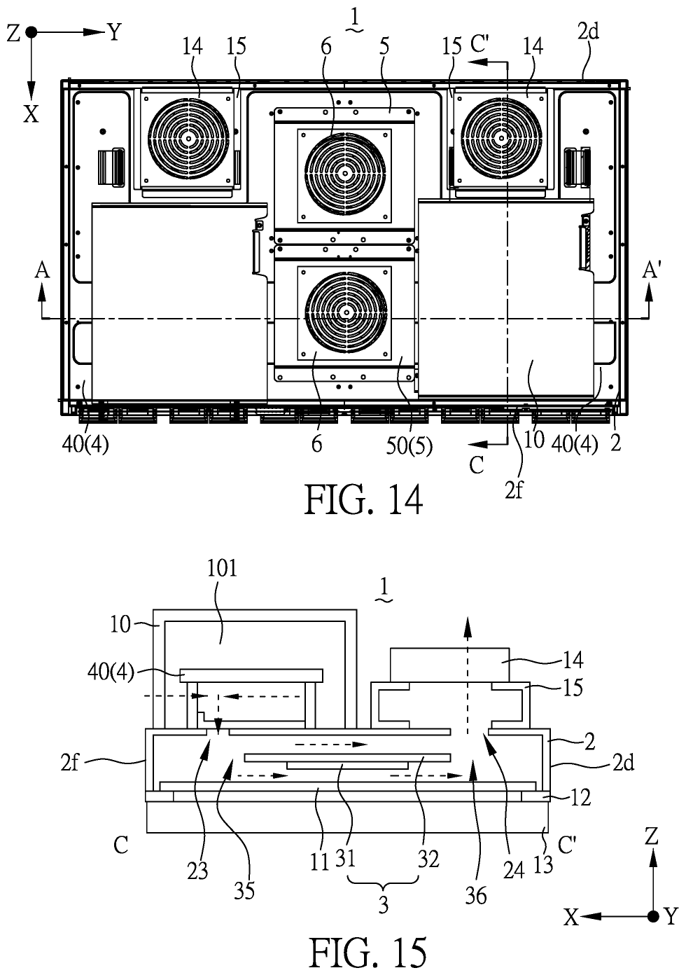

FIG. 14 is a schematic diagram of the electronic device 1 according to another embodiment of the present disclosure, and please refer to FIG. 14 and FIGS. 1 to 13 at the same time. Since some details and configurations of the embodiment of FIG. 14 are similar to those described in the previous embodiments (for example, the embodiment of FIG. 8 and FIG. 13), only the differences will be described in the following.

As shown in FIG. 14, the electronic device 1 may include both a fan 6 for air intake and a fan 14 for air exhaust. The electronic device 1 of this embodiment may be an integration of the embodiment of FIG. 8 and the embodiment of FIG. 13.

Please refer to FIG. 8, FIG. 13 and FIG. 14 at the same time. When the fan 6 and the fan 14 operate, the fan 6 may suck air into the guide member 5. According to the structure shown in FIG. 14 and FIG. 13, the air sucked by the fan 6 may be divided into at least two paths. After the air is blown into the space between the plate cover 10 and the back frame 2 through the third opening 53 of the guide member 5, part of the air may flow in between the first heat source 3 and the diffuser plate 11 through the fourth through hole 23 of the back frame 2 and the second interval 35 of the first heat source 3. In addition, at least part of the air between the first heat source 3 and the diffuser plate 11 may flow to the fan 14 through the fifth through holes 24 of the back frame 2 and the third interval 36 of the first heat source 3. As a result, the heat dissipation mechanism shown in FIG. 13 can be achieved.

In addition, since the space between the board cover 10 and the back frame 2 may be provided with the first opening 101, another part of the air may flow to the circuit board 40 to assist heat dissipation, and then dissipate from the first opening 101, as shown in FIG. 8.

Although this embodiment is achieved by integrating the heat dissipation mechanism of the embodiment of FIG. 13 and the heat dissipation mechanism of the embodiment of FIG. 8, in other embodiments, the heat dissipation mechanism of the embodiment of FIG. 13 may be combined with the embodiments of FIG. 2 to FIG. 6, respectively, but it is not limited thereto.

FIG. 15 is a schematic cross-sectional view of the electronic device in FIG. 14 taken along the line C-C′ according to another embodiment of the present disclosure, and please refer to FIG. 15 and FIGS. 1 to 13 at the same time. Since some details and configurations of the embodiment of FIGS. 14 and 15 are similar to those described in the aforementioned embodiments (e.g., the embodiment of FIG. 10), only the differences will be described in the following.

Please refer to FIG. 10, FIG. 14 and FIG. 15 at the same time. Similar to the previous embodiment, when the fan 6 and the fan 14 operate, the fan 6 may suck air, and the air sucked by the fan 6 may be divided into a plurality of airflow paths. After the air is blown into the space between the plate cover and the back frame through the third opening 53 of the guide member 5, part of the air may flow in between the first heat source 3 and the back frame 2 through the fourth through hole 23, while the other part of the air may flow in between the first heat source 3 and the diffuser plate 11 through the fourth through hole 23 and the second interval 35. In addition, as shown in FIG. 15, part of the air between the first heat source 3 and the diffuser plate 11 or part of the air between the first heat source 3 and the back frame 2 may also flow to the fan 14 through the third interval 36 and the fifth through hole 24 for being discharged out of the electronic device 1.

In addition, FIG. 10 shows another airflow path. Since the space between the plate cover 10 and the back frame 2 is provided with the first opening 101, for the aforementioned air blown in between the board cover and the back frame through the third opening 53 of the guide member 5, in addition to part of the air flowing to the first heat source 3 through the fourth through hole 23, another part of the air flows to the circuit board 40 to assist heat dissipation, and then dissipates through the first opening 101. Besides, when the fan 6 sucks part of the air into the guide member 5, there may be part of the air flowing in between the back frame 2 and the first heat source 3 through the fourth opening 54 and the first through hole 21, and even flowing in between the first heat source 3 and the diffuser plate 11 through the third through hole 33.

The present disclosure may at least compare the presence or absence of components in the electronic device 1 and/or the configuration of the components as evidence for whether an object falls within the scope of patent protection, but it is not limited thereto. Additionally, an airflow sensor or similar sensor may also be used to sense the presence or absence of airflow. Alternatively, a temperature sensor may also be used to determine the presence or absence of airflow, such as measuring the temperature of a specific position before and after the fan operates.

In one embodiment, the electronic device 1 fabricated in the aforementioned embodiments may be used as a touch device. Furthermore, if the electronic device 1 prepared in the aforementioned embodiments of the present disclosure is in the form of a display device or a touch display device, it may be applied to any product known in the art that requires a display screen for displaying images, such as monitors, mobile phones, notebook computers, video cameras, cameras, music players, mobile navigation devices, TVs, car dashboards, center consoles, electronic rearview mirrors, head-up displays, etc.

Accordingly, the present disclosure provides an improved electronic device, which can improve the heat dissipation efficiency of the electronic device 1, thereby solving the problem of poor heat dissipation in the prior art.

The features of the various embodiments of the present disclosure may be arbitrarily mixed and matched as long as they do not violate the spirit of the disclosure or conflict with each other.

The aforementioned specific embodiments should be construed as merely illustrative, and not limiting the rest of the present disclosure in any way.

What is claimed is:

1. An electronic device, comprising:
a back frame;
a first heat source disposed on a first side of the back frame;
a second heat source disposed on a second side of the back frame;
a guide member disposed on the second side of the back frame; and
a fan disposed corresponding to the guide member,
wherein at least part of an airflow path is formed between the first heat source and the second heat source.

2. The electronic device of claim 1, wherein the first heat source includes at least one light-emitting source.

3. The electronic device of claim 1, wherein the guide member is a fin type heat sink or a fan support frame, and the fan support frame has at least one opening facing the second heat source.

4. The electronic device of claim 1, wherein at least part of the second heat source is disposed above the guide member.

5. The electronic device of claim 1, further comprising a second guide member and a heat pipe, wherein the second guide member is disposed adjacent to the guide member, and the heat pipe is disposed above the second guide member.

6. The electronic device of claim 1, further comprising a second guide member disposed adjacent to the guide member, wherein the second guide member has a groove.

7. The electronic device of claim 1, further comprising a board cover disposed on the second heat source.

8. The electronic device of claim 1, wherein the back frame has at least one through hole, and the fan is adjacent to the through hole.

9. The electronic device of claim 8, further comprising a diffuser plate, wherein an interval is provided between the first heat source and the diffuser plate and, when the fan operates, air flows in between the diffuser plate and the first heat source.

10. The electronic device of claim 8, wherein the fan is disposed to extract air from the through hole.

11. The electronic device of claim 1, wherein the first heat source includes at least one light-emitting source and a circuit carrier board.

12. The electronic device of claim 1, wherein the second heat source includes a circuit board and electronic components disposed on the circuit board.

13. The electronic device of claim 1, wherein an interval is provided between the first heat source and the back frame.

14. The electronic device of claim 9, wherein a dimming device is arranged on one side of the diffuser plate away from the first heat source.

15. The electronic device of claim 12, wherein a plurality of support members are arranged between the circuit board and the back frame for supporting the circuit board so as to form an interval space between the circuit board and the back frame.

16. The electronic device of claim 1, wherein the guide member is a fin type heat sink and includes at least a flow channel extending to at least one edge of the guide member.

17. The electronic device of claim 7, wherein a space is defined in an overlap portion between the board cover and the back frame, and the space has at least one opening.

18. The electronic device of claim 6, wherein the second guide member includes a plurality of flow channels, and the groove is disposed between the plurality of flow channels.

19. The electronic device of claim 8, wherein the guide member has an opening corresponding to the first through hole.

20. The electronic device of claim 1, wherein the first heat source has at least one through hole.
